(19) United States
(12) Patent Application Publication
(10) Pub. No.: US 2005/0023226 A1
(43) Pub. Date: Feb. 3, 2005

(54) Oil filter mounting plate assembly

(76) Inventors: Ryan A Bastick, St Clair, MI (US); Gilbert C Quick JR., Livonia, MI (US)

Correspondence Address: Raymond E Scott;Howard & Howard Attorneys, 39400 Woodward Avenue, Suite 101, Bloomfield Hills, MI, 48304-5151, US

(21) Appl. No.: 10/493,797

(22) PCT Filed: Jun. 3, 2002
(86) PCT No.: PCT/US02/17239

Related U.S. Application Data
(60) Provisional application No. 60/296,636, filed on Jun. 7, 2001.

(51) Int. Cl. C02F 1/48

(52) U.S. Cl. 210/748

(57) ABSTRACT

An oil filter mounting plate assembly formed of two components comprising a plate having a central polygonal opening and a nut having a polygonal periphery configured to be received in the polygonal opening in a press fit including lateral grooves on opposed sides of the nut forming a mechanical interlock with the plate. The nut is internally threaded for threaded securement to the pipe communicating with the oil recirculation system of an internal combustion engine.

### FIELD OF THE INVENTION

The present invention relates to a mounting plate for oil filters of the type used for internal combustion engines.

### BACKGROUND OF THE INVENTION

Current internal combustion engines are internally lubricated during operation with a recirculating oil system. In order to keep the oil in the recirculating oil system free of particulates that could cause premature wear of engine parts, the oil is further circulated through a filter. In order to maintain the oil as particulate free as possible, the oil filter requires periodic replacement. Thus, oil filters are a disposable commodity which must be mass produced in large quantities at a minimal cost.

A typical oil filter for an internal combustion engine includes a cup or can-shaped enclosure having a cylindrical side wall, an open end and a closed end. A filtering media or element is received in the enclosure and the open end of the enclosure is then affixed to an oil filter mounting plate generally by crimping. The oil filter mounting plate as presently used is integrally formed from plate steel and includes a circular annular planar rim portion which receives the oil filter housing, a depressed annular central portion and an integral upstanding central boss having an internally threaded bore which threadably receives an oil pipe communicating with the engine block. The depressed central portion surrounding the boss includes an integral annular inclined portion having a plurality of spaced openings which receive the oil from the engine block. The oil is then circulated through the filter media and returned to the engine block through the central opening in the integral boss.

Thus, the prior art oil filter mounting plate integrally formed from plate steel requires expensive forging, forming and machining operations and threading of the internal surface of the boss. In addition to the expense of and capital investment required for forging and extruding the integral boss of the prior art oil filter mounting plate, it is generally not possible to accurately form the boss and the bore through the boss perpendicular to the plane of the plate. Thus, because the bore must be internally threaded in the axis of the bore, the resulting threaded bore is not perpendicular to the plane of the plate. Then, when the prior art filter mounting plate is threaded on the pipe communicating with the engine block, the plate is canted relative to the bearing surface of the block surrounding the pipe, resulting in a poor seal and leakage. This problem is solved by the two piece oil filter mounting plate of this invention.

There is therefore a need for an oil filter mounting plate which is less expensive to manufacture and which may be manufactured using mass production techniques but which provides the advantages of a unitary oil filter mounting plate including a central internally threaded bore having sufficient thickness for a plurality of threads.

### SUMMARY OF THE INVENTION

The oil filter mounting plate assembly of this invention is formed from at least two parts including a plate having a circular outer periphery and a central portion having a polygonal opening therethrough, and a nut press fit in the polygonal opening in generally sealed relation having a thickness greater than the plate and including an internally threaded central opening or bore. The nut has a thickness greater than the plate such that the internally threaded central opening of the nut thus has sufficient threads for threaded sealed securement to the oil pipe extending from the engine block, but eliminates the requirement for forging and threading after forging of a unitary part. The nut includes a polygonal outer periphery configured to be received in the polygonal opening of the plate in a press fit and a linear groove defined in opposed sides of the polygonal outer periphery of the nut receiving the plate and permanently affixing the nut to the plate in sealed relation.

In the preferred embodiment, the polygonal opening through the central portion of the plate has at least five sides and the polygonal outer periphery of the nut includes a corresponding number of sides, more preferably at least six sides. In the disclosed embodiment, the linear grooves defined in the opposed sides of the polygonal periphery of the nut are defined by spaced opposed lips adjacent the opposite surfaces of the nut including a first lip overlying an adjacent surface of the plate and a second lip engaging an outer surface of the plate forming a secure and sealed attachment. In the disclosed embodiment, the bottom surface of the grooves is inclined to facilitate attachment of the nut to the plate.

Further, in the preferred embodiment of the oil filter mounting plate of this invention, the plate is generally configured similar to the prior mounting plate including a generally planar annular outer rim portion having a circular outer periphery to receive the cylindrical rim of the enclosure or housing of the oil filter, an annular inclined portion integral with the planar outer rim and a planar central portion surrounding the polygonal central opening, wherein the annular inclined portion includes a plurality of spaced openings which receive the oil from the engine block as described above.

The oil filter mounting plate assembly of this invention may thus be formed by conventional forming techniques which do not require forging and internally threading of a boss following manufacture of the mounting plate. Further, because the bore of the nut is threaded prior to press fitting the nut in the plate, the thread nut bore is perpendicular to the plane of the plate, reducing leakage. The mounting plate may be formed from a plate of sheet steel and the nut may be secured within the central polygonal opening in a die press. Other advantages and meritorious features of the oil filter mounting plate of this invention will be more fully understood from the following description of the preferred embodiments, the appended claims and the drawings, a brief description of which follows.

### BRIEF DESCRIPTION OF THE DRAWINGS

FIG. 1 is a perspective view of a preferred embodiment of the oil filter mounting plate assembly of this invention from one side of the assembly;

FIG. 2 is a top view of the oil filter mounting plate assembly of FIG. 1 from a side of the assembly opposite to FIG. 1;

FIG. 3 is a side crosssectional view of FIG. 2 in the direction of view arrows 3-3;

FIG. 4 is a perspective view of the nut of the oil filter mounting plate assembly illustrated in FIGS. 1 and 2;

FIG. 5 is a top view of the nut illustrated in FIG. 4;

FIG. 6 is a side crosssectional view of the nut illustrated in FIG. 5 in the direction of view arrows 6-6; and

FIG. 7 is a top view of the plate illustrated in FIG. 2.

### DESCRIPTION OF THE PREFERRED EMBODIMENTS

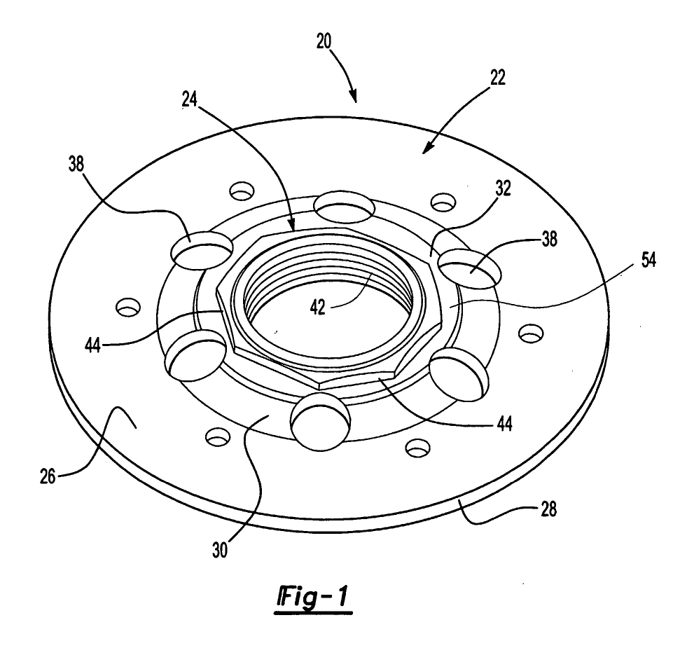

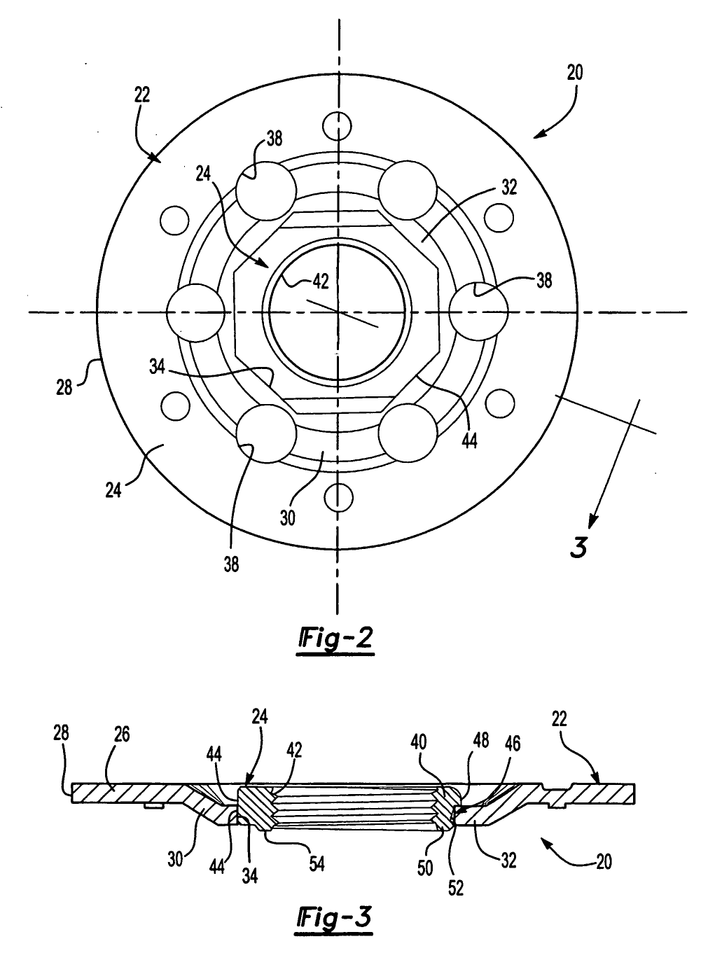

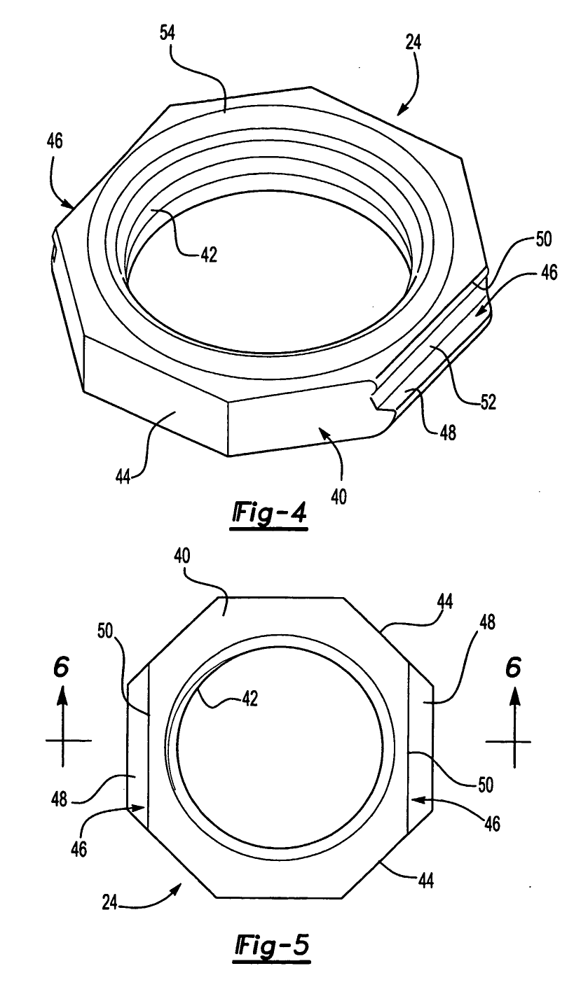

As set forth above, the oil filter mounting plate assembly 20 of this invention shown in FIGS. 1 to 3 may be conventionally formed from two components comprising the plate 22 shown in FIG. 7 and the nut shown in FIGS. 4 to 6. The plate 22 may be formed from a metal plate, preferably steel, and includes a planar outer rim portion 26 having a circular peripheral edge 28, an annular inclined portion 30 and a planar generally annular inner portion 32 having a polygonal opening 34. Because the plate 22 has a uniform thickness, no forging is required, substantially reducing the cost as compared with the prior oil filter mounting plate assembly described above. The polygonal opening 34 preferably has greater than four sides, preferably at least six sides and most preferably eight sides, as shown in FIG. 7 for example. The sides of the polygonal opening 34 are preferably linear and the polygon defined by the sides is preferably regular as shown. The inclined annular portion 30 includes a plurality of openings 38 which are preferably equally spaced as shown in FIGS. 1, 2 and 7 which form the inlet openings for the oil filter as described above and further described below. The openings 38 may be circular as shown and formed by conventional punching techniques known in the art.

The nut 22 best shown in FIGS. 4 to 6 includes an annular body 40 including a central internally threaded bore 42 and a polygonal periphery 44. As will be understood from the description of a preferred method of forming the oil filter mounting plate assembly 20 of this invention below, the polygonal periphery 44 of the nut 22 is substantially identical to the polygonal opening 34 in the plate 22 except for the grooves 46 described below. That is, the polygonal periphery 44 of the nut has the same number of sides as the polygonal opening 44 in the plate 22 and the sides of the polygonal periphery 44 of the nut are preferably linear.

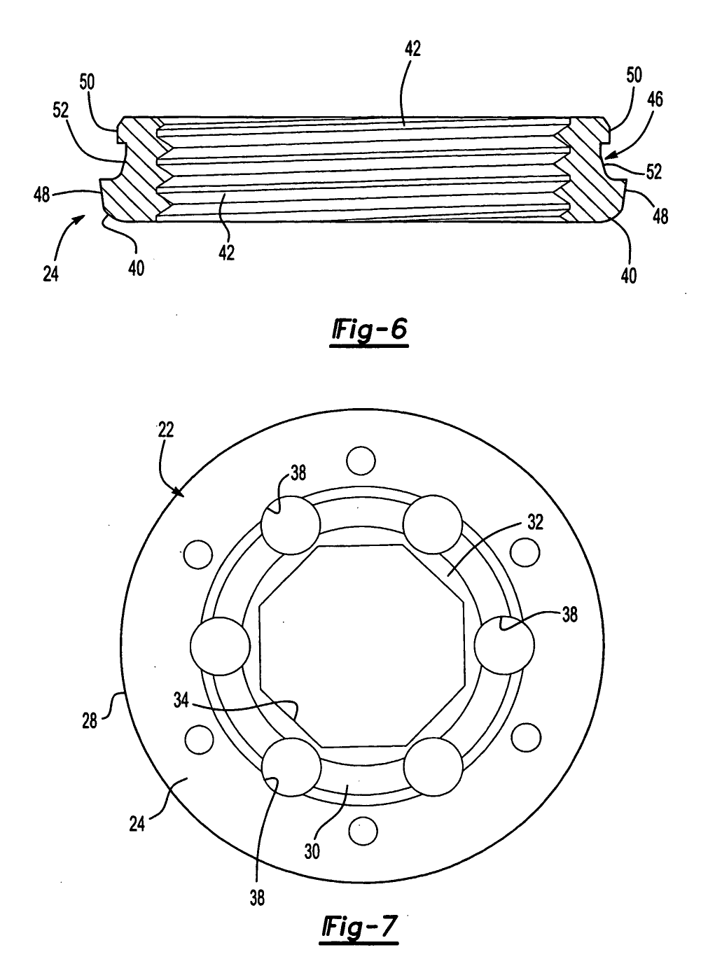

The nut 24 preferably includes at least two linear grooves 46 on opposed sides of the polygonal periphery each including a linear lip 48 adjacent one side of the plate 26 and a smaller lip 50 as best shown in FIG. 6. The bottom wall 52 of the groove 46 is preferably inclined toward the smaller lip 50 as shown in FIGS. 3 and 6. The lips 48 and 50 extend linearly as shown in FIG. 5. In the most preferred embodiment, the diameter or major dimensions of the polygonal periphery 44 of the nut is slightly greater than the diameter or major dimensions of the polygonal opening 34 in the plate 22, such that the nut 24 must be press fit into the polygonal opening 34 in the plate and the lip 50 overlies the surface of the planar inner portion 32 of the plate as shown in FIG. 3. In the most preferred embodiment of the oil filter mounting plate assembly 20, the nut further includes an annular bearing surface 54 as best shown in FIGS. 1 and 4.

The oil filter mounting plate assembly 20 may be assembled in a conventional die press. After forming the plate 22 from a sheet or plate of metal, preferably steel, and the nut from a metal preferably having at least the same hardness as the plate 22, the nut 24 may be fed to an installation head attached to one platen of a die press, wherein the plate is supported on a die fixture or die button on the opposed platen of the die press (not shown). In the most preferred method of installation, the plate 22 may be simultaneously formed by suitable dies in the die press. The nut 24 is oriented in the installation head, such that the polygonal periphery 44 of the nut corresponds to the polygonal opening 34 of the plate with the lip 50 of the groove 46 opposite the plate. As the die press is closed, the nut 24 is permanently installed in and attached to the plate 22 as best shown in FIG. 3. The combination of the press fit and the interlock of the nut to the plate provided by the grooves 46 forms an essentially sealed connection between the nut and the plate, although an air tight seal is not required.

As will be understood by those skilled in this art, various modifications may be made to the oil filter mounting plate assembly 20 of this invention within the purview of the appended claims. For example, the polygonal opening 34 in the plate 22 and the polygonal periphery 44 of the nut 24 may have six sides and the linear grooves 46 may be provided on more than two of the polygonal sides 44 of the nut 24. However, the grooves 46 may be formed in the polygonal nut on opposed sides simultaneously further reducing the cost. As described above, the oil filter mounting plate assembly 20 of this invention may be used with any conventional oil filter including a housing or enclosure including a tubular cylindrical side wall, wherein the open end of the tubular side wall is crimped or otherwise secured to the oil filter mounting plate assembly. The oil is then circulated through the oil filter (not shown) through the openings 38, filtered by the filter media (not shown) and returned to the engine block through a pipe threaded to the threaded opening 42 of the assembly. Having described the oil filter mounting plate assembly of this invention, it is now claimed as follows.

1. An oil filter mounting plate assembly, comprising:
a plate including a circular outer periphery and a central portion having a polygonal opening therethrough; and
a nut press fit in said polygonal opening in generally sealed relation having a thickness greater than said plate, including an internally threaded central opening, a polygonal outer periphery configured to be received in said polygonal opening, and a linear groove defined in opposed sides of said polygonal outer periphery receiving said plate and permanently affixing said nut to said plate.

2. The oil filter mounting plate assembly as defined in claim 1, wherein each of said linear grooves is defined by a first lip portion overlying an adjacent surface of said plate and a spaced second lip portion.

3. The oil filter mounting plate assembly as defined in claim 2, wherein said second lip portion engages an internal surface of said polygonal opening on opposed sides of said opening.

4. The oil filter mounting plate assembly as defined in claim 3, wherein said grooves each include an inclined bottom surface.

5. The oil filter mounting plate assembly as defined in claim 1, wherein said nut includes an annular bearing surface surrounding said internally threaded central opening.

6. The oil filter mounting plate assembly as defined in claim 1, wherein said plate includes a generally planar annular rim portion and a depressed central portion surrounding said polygonal opening.

7. The oil filter mounting plate assembly as defined in claim 6, wherein said depressed central portion is defined by an annular inclined wall integral with said annular rim portion having a plurality of spaced openings therethrough and an annular central planar portion surrounding said polygonal opening.

8. An oil filter mounting plate assembly, comprising:
a plate including a generally planar outer rim portion having a circular outer periphery and a depressed central portion integral with said outer rim portion having a regular polygonal opening therethrough; and
a nut press fit in said polygonal opening in generally sealed relation having a thickness greater than said plate including an internally threaded central opening, a regular polygonal outer periphery configured to be received in said polygonal opening and a linear groove defined on opposed sides of said polygonal outer periphery receiving said plate including a first lip portion overlying an adjacent surface of said plate permanently affixing said nut to said plate.

9. The oil filter mounting plate assembly as defined in claim 8, wherein each of said grooves is defined by said first lip portion and a second lip portion spaced from said first lip portion engaging an internal surface of said polygonal opening.

10. The oil filter mounting plate assembly as defined in claim 8, wherein said nut includes a circular annular bearing surface surrounding said internally threaded central opening.

11. The oil filter mounting plate assembly as defined in claim 8, wherein said polygonal opening has more than four linear inner side walls.

12. The oil filter mounting plate assembly as defined in claim 11, wherein said polygonal opening has at least six linear inner side walls.
